(19) United States
(12) Patent Application Publication
(10) Pub. No.: US 2006/0026656 A1
(43) Pub. Date: Feb. 2, 2006

(54) Video/audio player with remote-control unit

(75) Inventor: Hung-Chang Chen, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/180,440

(22) Filed: Jul. 13, 2005

(30) Foreign Application Priority Data
Jul. 30, 2004 (CN) 200410050973.2

(51) Int. Cl. H04N 7/173; H04N 7/16; H04N 5/44

(52) U.S. Cl. 725/100; 725/131; 725/151; 348/725

(57) ABSTRACT

A video/audio player includes a main body, a lid, and a remote-control unit. The main body includes a first recessed portion. The lid is pivotally connected to the main body. The remote-control unit is detachably received in the first recessed portion.

### BACKGROUND OF THE INVENTION

1. Field of the Invention

This invention is related to audio/video players, and particularly to an audio/video player with a remote-control unit.

2. General Background

Over the past several decades there has been widespread adoption by consumers of various types of audio/video players. Devices such as digital versatile disk (DVD) players, compact disk (CD) players, televisions (TVs), set-top boxes, radio receivers, videocassette recorders (VCRs), and other similar audio/video players have become commonplace in many households. Many of these audio/video players are designed to be operable by built-in control panels, which allow users to control different functions such as adjusting the sound volume, stopping a tape, rewinding the tape, fast forwarding the tape, etc. However, the built-in control panel is inconvenient when a user needs to perform specific functions frequently. In view of this disadvantage, wireless remote-control units have been extensively developed. Using a wireless remote-control unit that transmits control instructions to receiver units via infra-red (IR) signals, a user can perform a variety of operations such as switching to a different track on a DVD playing in a DVD player, or changing the volume or channel of a television, all from a convenient location a distance away from the audio/video player.

However, traditional audio/video players still have a built-in control panel for satisfying some specific needs of users, in addition to a separate remote-control unit. In general, the built-in control panel increases the cost, size and complexity of the audio/video player. Further, a problem with having a separate remote-control unit is that it is liable to be dropped or even lost by careless users.

Therefore, a heretofore unaddressed need exists in the industry to address the aforementioned deficiencies and inadequacies.

### SUMMARY

A video/audio player includes a main body, a lid, and a remote-control unit. The main body includes a first recessed portion. The lid is pivotally connected to the main body. The remote-control unit is detachably received in the first recessed portion.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views, in which:

FIG. 1 is an exploded, isometric view of a video/audio player with a remote-control unit in accordance with an embodiment of the present invention;

FIG. 2 is an assembled view of FIG. 1;

FIG. 3 is an enlarged view of a key module of the remote-control unit of FIG. 1; and

FIG. 4 is an isometric view of a video/audio player in accordance with another embodiment of the present invention, showing a remote-control unit thereof detached from a main body thereof.

### DETAILED DESCRIPTION OF PREFERRED EMBODIMENTS

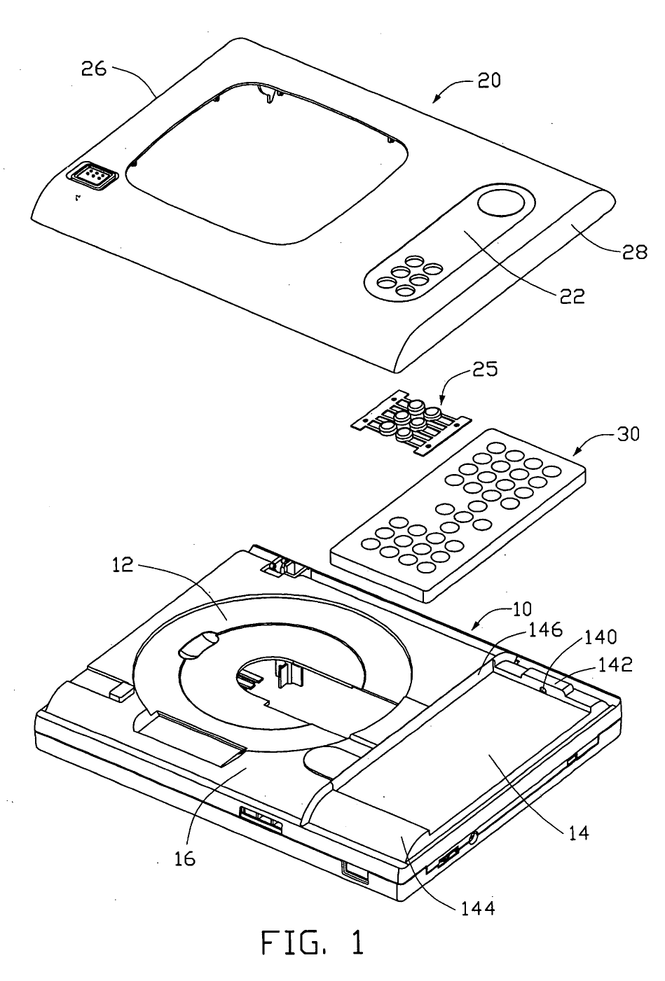

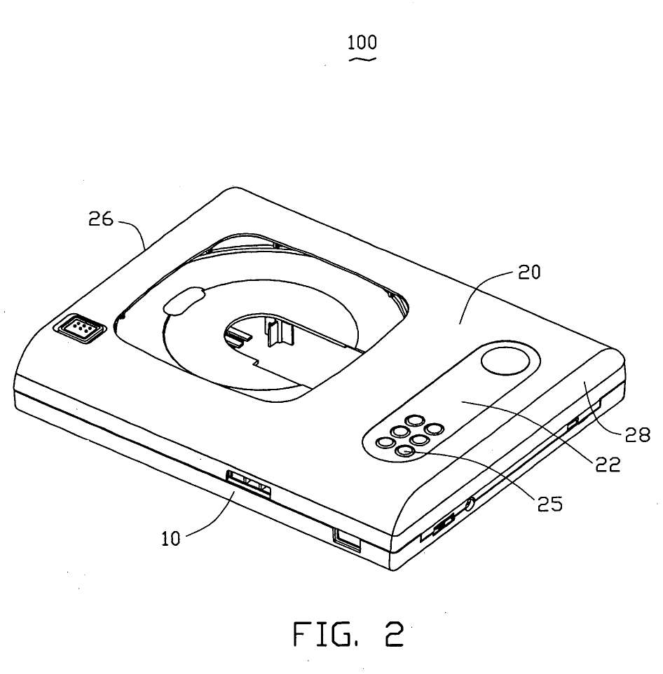

Referring to FIG. 1 and FIG. 2, a multimedia (video/audio) player 100 in accordance with an embodiment of the present invention is shown. The video/audio player 100 may be a digital versatile disk (DVD) player, a compact disk (CD) player, a television (TV), a set-top box, a radio receiver, a videocassette recorder (VCR), or any other similar kind of audio/video player. The video/audio player 100 includes a main body 10 having means to generate multimedia signals, a lid 20, and a wireless remote-control unit 30. The lid 20 is pivotally connected to the main body 10 via at least one pivot (not labeled). The remote-control unit 30 is received in the main body 10, and is detachable therefrom.

The main body 10 is substantially rectangular, and has a top surface 16. On the top surface 16, a first tray 12 is formed for receiving a disc (not shown) therein so as to form means to generate multimedia signals, and a first recessed portion 14 is formed for receiving the wireless remote-control unit 30 therein. The remote-control unit 30 can be rectangular, elliptical or have any other desired shape. The first recessed portion 14 is substantially configured to have the same shape as the remote-control unit 30. When the remote-control unit 30 is received in the first recessed portion 14, a top surface of the remote-control unit 30 is substantially flush with the top surface 16 of the main body 10. In another exemplary embodiment, the first recessed portion 14 can also have a larger size than the remote-control unit 30. In such case, the top surface of the remote-control unit 30 may be lower than the top surface 16 of the main body 10 when the remote-control unit 30 is received in the first recessed portion 14.

The first recessed portion 14 has a front wall 142, a back wall 144 opposite to the front wall, and a sidewall 146 interconnecting the front wall 142 and the back wall 144. A first transceiver 140 is arranged in the front wall 142. The first transceiver 140 is generally a wireless signal receiving unit, such as an infra-red (IR) signal receiving unit, a Bluetooth signal receiving unit, a Wi-Fi signal receiving unit, or the like. In other embodiments, the first transceiver 140 can be arranged in the back wall 144, the side wall 146, or in a bottom wall of the first recessed portion 14.

In the illustrated embodiment, a second transceiver which is similar to the first transceiver 140 is arranged at an outside surface of the video/audio player 100, such as in a second sidewall 28 of the lid 20.

The lid 20 is configured to correspond to a shape of the main body 10. When the lid 20 is in a closed position, the lid 20 completely covers the main body 10. The lid 20 has a first sidewall 26 and the second sidewall 28, which are respectively at two opposite lateral sides of the lid 20. The lid 20 defines a second recessed portion 22. A key module 25 is disposed in the second recessed portion 22.

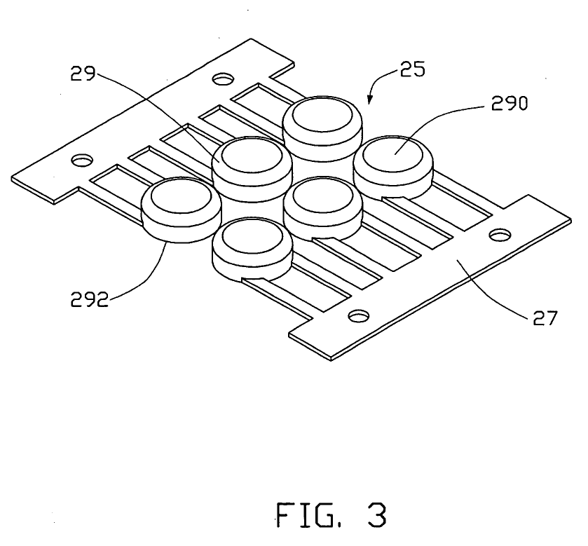

Referring also to FIG. 3, the key module 25 includes a panel 27 and a key array 29. The panel 27 and the key array 29 are integrally formed together by a single-shot molding method. The key array 29 includes a plurality of keys. Each of the keys is associated with a specific function, such as “power on/off,” “tape forward,” “tape rewind,” etc. Each key of the key array 29 includes a bump 292 and a key top 290 covering the bump 292. The second recessed portion 22 defines an array of through holes (not labeled) corresponding to the key array 29, so that each key of the key array 29 can extend through a corresponding through hole.

To place the remote-control unit 30 in the first recessed portion 14, firstly, the lid 20 is rotated up to an open position. The remote-control unit 30 is placed in the first recessed portion 14, and the lid 20 is rotated down to a closed position. The remote-control unit 30 is thus covered by the lid 20 (see FIG. 2). The key array 29 is arranged above the remote-control unit 30, with each key of the key array 29 aligned with a corresponding key on the remote-control unit 30. When a key of the key array 29 is pressed, the key transfers the downward force onto a corresponding key of the remote-control unit 30. With the downward force acting on the key of the remote-control unit 30, a control signal is generated and transmitted from the remote-control unit 30 to the first transceiver 140, and a specific function corresponding to the key is thus selected. In this way, the key array 29 and the remote-control unit 30 cooperatively function as a built-in control panel of the main body 10.

When the remote-control unit 30 is detached from the main body 10 and serves as a separate remote-control unit, a user can select a specific function by directly pressing an associated key on the remote-control unit 30. A control signal is generated and transmitted from the remote-control unit 30 to the second transceiver 24 by pressing the associated key.

In this embodiment, the remote-control unit 30 can be placed in the first recessed portion 14 without using any securing mechanism. However, if desired, a securing mechanism can be employed in order to ensure securing of the remote-control unit 30 in the first recessed portion 14. The securing mechanism can include, but is not limited to, a pair of grooves defined in the front wall 142 and the back wall 144 of the first recessed portion 14, or a hook (not shown) formed at the bottom wall of the first recessed portion 14.

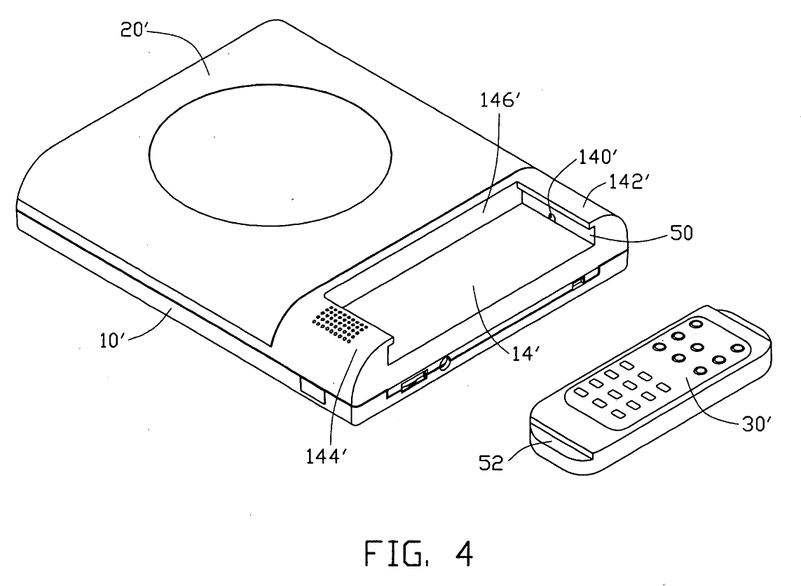

Referring to FIG. 4, a video/audio player 100′ in accordance with another embodiment of the present invention is shown. The video/audio player 100′ is similar to the video/audio player 100, and includes a main body 10′, a lid 20′, and a remote-control unit 30′. The main body 10′ defines a first recessed portion 14′ for receiving the remote-control unit 30′ therein. Instead of being completely covered by the lid 20 as shown in FIG. 1, the remote-control unit 30′ is not covered by the lid 20′ at all when the remote-control unit 30′ is received in the first recessed portion 14′.

That is, the lid 20′ only partially covers the main body 10′. The first recessed portion 14′ is exposed to an exterior of the video/audio player 100′, for receiving the remote-control unit 30′ without having to open or close the lid 20′. In addition, a securing mechanism is provided, to prevent the remote-control unit 30′ from accidentally detaching from the main body 10′ when the remote-control unit 30′ is stationed in the first recessed portion 14′. In the illustrated embodiment, a pair of grooves 50 are defined in a front wall 142′ and a back wall 144′ of the first recessed portion 14′ respectively. A pair of protuberances 52 is correspondingly formed at two opposite ends of the remote-control unit 30′ respectively. When the remote-control unit 30′ is not in use remotely, a user can slide the remote-control unit 30′ along the grooves 50 until the remote-control unit 30′ is fitted entirely within the first recessed portion 14′. The remote-control unit 30′ then serves as a built-in control panel. When the user needs to use the remote-control unit 30′ remotely, the user can slide the remote-control unit 30′ out from the first recessed portion 14′ until it is completely detached from the main body 10′. Whether the remote-control unit 30′ is stationed in the first recessed portion 14′ or is detached from the main body 10′, the control signals from the remote-control unit 30′ are received by a transceiver 140′ arranged in the first recessed portion 14′. In other exemplary embodiments, the securing mechanism can comprise one or more clips, wedges, blocks, or any other suitable means, which are arranged in or at the first recessed portion 14′ and/or on or at the remote-control unit 30′. Part or all of the securing mechanism can be arranged at any suitable position of the first recessed portion 14′, including the front wall 142′, the back wall 144′, and/or a sidewall 146′.

In the above-described embodiments, the first recessed portion 14, 14′ is located in a right side of the main body 10, 10′. However, the first recessed portion 14, 14′ may instead be arranged at any other desired position in the main body 10, 10′.

Further, the embodiments described herein are merely illustrative of the principles of the present invention. Other arrangements and advantages may be devised by those skilled in the art without departing from the spirit and scope of the present invention. The present invention should be deemed not to be limited to the above description but by the spirit and scope of the claims that follow, and their equivalents.

What is claimed is:

1. A video/audio player, comprising:
a main body comprising a first recessed portion;
a lid pivotally connected to the main body; and
a remote-control unit detachably received in the first recessed portion.

2. The video/audio player as claimed in claim 1, wherein the main body comprises a first transceiver for receiving control signals from the remote-control unit.

3. The video/audio player as claimed in claim 2, wherein the first transceiver is arranged at the first recessed portion.

4. The video/audio player as claimed in claim 1, wherein the lid completely covers the main body.

5. The video/audio player as claimed in claim 4, wherein the lid comprises a key array, which is configured to correspond to associated keys of the remote-control unit.

6. The video/audio player as claimed in claim 4, further comprising a second transceiver arranged at an outside surface of the video/audio player.

7. The video/audio player as claimed in claim 1, wherein the lid partially covers the main body.

8. The video/audio player as claimed in claim 7, wherein the first recessed portion is exposed to an exterior of the video/audio player, for directly receiving the remote-control unit.

9. The video/audio player as claimed in claim 7, wherein the remote-control unit is mechanically retained in the first recessed portion via a securing mechanism.

10. The video/audio player as claimed in claim 9, wherein the securing mechanism comprises a pair of grooves in two opposite walls of the first recessed portion, and a pair of corresponding protuberances at two opposite ends of the remote-control unit, the protuberances being receivable in the grooves.

11. A multimedia player, comprising:
a main body comprising means to generate multimedia signals; and
a wireless remote-control unit detachably receivable in said main body and operable by a user of said player to control said multimedia player and generation of said multimedia signals by means of wireless transmission of control signals from said unit to said main body regardless of a condition thereunder selected from a first condition that said unit is detached from said main body for user's remote-control and a second condition that said unit is received by said main body to allow direct user's operation on said unit.

12. The multimedia player as claimed in claim 11, further comprising a lid to cover parts of said main body, and a wireless signal receiving unit is disposed at a location selected from a first location defined between said lid and said main body, and a second location defined on said main body outside coverage of said lid.

13. A method of operation a multimedia player, comprising the steps of:
housing means to generate multimedia signals for said multimedia player in a main body of said multimedia player;
reserving a recessed portion in said main body to detachably receive a unit for wireless remote-control on said player and said means; and
allowing user's operation on said unit by using wireless transmission of said unit at a first location of said unit where said unit is received in said recessed portion of said main body, and at a second location of said unit where said unit is detached from said main body for said remote-control.

14. The method as claimed in claim 13, wherein said player comprises a lid to partially cover said main body and wholly cover said unit, and said unit is under said user's operation through said lid.
